(19) United States
(12) Patent Application Publication
(10) Pub. No.: US 2025/0317887 A1
(43) Pub. Date: Oct. 9, 2025

(54) METHOD FOR PERFORMING A SIDELINK POSITIONING/RANGING PROCEDURE IN A COMMUNICATION SYSTEM AND A NETWORK SYSTEM

(71) Applicant: Beijing Xiaomi Mobile Software Co., Ltd., Beijing (CN)

(72) Inventor: Wei LU, Beijing (CN)

(21) Appl. No.: 18/865,486

(22) PCT Filed: May 16, 2022
(86) PCT No.: PCT/CN2022/093159

§ 371 Date: Nov. 13, 2024

(51) Int. Cl. H04W 64/00; H04W 12/02; H04W 92/18

(52) U.S. Cl. CPC H04W 64/00; H04W 12/02; H04W 92/18

(57) ABSTRACT

A method for performing a sidelink positioning procedure and/or a ranging procedure in a communication system, includes: sending, by a network function (NF), a data retrieval request to a unified data management function (UDM), wherein the data retrieval request prompts the UDM to provide privacy profile data of a first User Equipment (UE1) and a second User Equipment (UE2), and wherein the privacy profile data indicates whether a first user consent to share location information associated with the UE1 is present and whether a second user consent to share location information associated with the UE2 is present; receiving, by the NF, the privacy profile data from the UDM; evaluating, by the NF, the privacy profile data of the UE1 and UE2; and performing the sidelink positioning procedure and/or the ranging procedure.

### CROSS REFERENCE TO RELATED APPLICATION(S)

This application is a U.S. national phase of International Application No. PCT/CN2022/093159, filed on May 16, 2022, the entire content of which is incorporated herein by reference.

### TECHNICAL FIELD

The present disclosure relates to a method for performing a sidelink positioning procedure and/or a ranging procedure (also referred to as SL positioning/ranging or ranging/SL positioning) in a communication system, in particular in a 5G communication system. The present disclosure also relates to a method for providing assistance information to a network function for performing ranging/SL positioning in a communication system and a method for providing position estimation data corresponding to a first User Equipment (also referred to as UE1) and a second User Equipment (also referred to as UE2). Furthermore, the present disclosure relates to a network system that is configured to be implemented in a communication system, in particular to be implemented in a 5G communication system. Finally, the present disclosure relates to a User Equipment (UE) to be implemented in a communication system and a computer program product.

### BACKGROUND

Ranging and SL positioning belong to the key functions in a communication system such as 5G communication systems. In some applications, the mentioned techniques allow an efficient communication between two vehicles (also referred to as V2V or vehicle-to-vehicle communication) or between a vehicle and another component being located in the vicinity of the vehicle, such as a traffic lamp or a monitoring device of a construction area (also referred to as V2X or vehicle-to-everything communication). Therefore, ranging/SL positioning belongs to crucial techniques when it comes to critical applications such as autonomous driving.

Due to the significance of ranging/SL positioning, different techniques for providing high-precision positioning measurements are suggested in different communication standards such as in the 5G communication standard.

However, due to reasons of privacy protection, a user who is registered with his User Equipment in a communication system and who uses various communication services (such as voice services or message services) of a telecommunication provider may not consent to sharing his current location (i.e. the current location of the User Equipment used by him) with the provider.

### SUMMARY

In order to solve the above-mentioned problem, according to one aspect of the present disclosure, a method is proposed for performing a sidelink positioning procedure and/or a ranging procedure in a communication system, in particular in a 5G communication system, wherein the communication system comprises a network system, a first User Equipment (UE1) and a second User Equipment (UE2), and wherein the network system comprises a network function (NF), a unified data management function (UDM) and an access and mobility management function (AMF), and the UE1 and the UE2 registers with the network system, and wherein the method comprises:
sending, by the NF, a data retrieval request to the UDM, wherein the data retrieval request prompts the UDM to provide privacy profile data of the UE1 and the UE2, and wherein the privacy profile data indicates whether a first user consent to share location information associated with the UE1 is present and whether a second user consent to share location information associated with the UE2 is present;
receiving, by the NF, the privacy profile data from the UDM;
evaluating, by the NF, the privacy profile data of the UE1 and UE2;
performing the sidelink positioning procedure and/or the ranging procedure in case the preceding evaluation has resulted in the presence of the first user consent to share location information associated with the UE1 and in the presence of the second user consent to share location information associated with the UE2.

According to a further aspect of the present disclosure, a method is proposed for providing, by a unified data management (UDM), assistance information to a network function (NF), for performing a sidelink positioning procedure and/or a ranging procedure in a communication system, in particular in a 5G communication system, wherein the communication system comprises a network system, a first User Equipment (UE1) and a second User Equipment (UE2), and wherein the network system comprises the network function (NF), the unified data management function (UDM) and an access and mobility management function (AMF), the method comprising:
receiving, by the UDM, a data retrieval request from the NF, wherein the data retrieval request prompts the UDM to provide privacy profile data of the UE1 and the UE2, and wherein the privacy profile data indicates whether a first user consent to share location information associated with the UE1 is present, and whether a second user consent to share location information associated with the UE2 is present;
retrieving, by the UDM, the privacy profile data of the UE1 and the UE2 from a database within the UDM, in particular from a unified data repository (UDR) of the UDM; and
sending, by the UDM, the retrieved privacy profile data of the UE1 and the UE2 to the NF.

According to a further aspect of the present disclosure, a method is proposed for providing, by an access and mobility management function (AMF), position estimation data for a first User Equipment (UE1) and a second User Equipment (UE2) for performing a sidelink positioning procedure and/or a ranging procedure in a communication system, in particular in a 5G communication system, wherein the communication system comprises a network system, the first User Equipment (UE1) and the second User Equipment (UE2), and wherein the network system comprises a network function (NF), a unified data management function (UDM) and the access and mobility management function (AMF), the method comprising:
receiving, by the AMF, a request message for obtaining the position estimation data for the UE1 and/or the UE2 being associated with an area-specific consent data from the NF or from the UDM;
sending, by the AMF, the requested position estimation data for the UE1 and/or the UE2 associated with the area-specific consent data to the requesting NF or the requesting UDM.

According to a further aspect of the present disclosure, a network system is proposed that can be implemented in a communication system, in particular to be implemented in a 5G communication system, wherein the network system comprises a network function (NF), a unified data management function (UDM) and an access and mobility management function (AMF), wherein the NF is configured to:
send a data retrieval request to the UDM, wherein the data retrieval request prompts the UDM to provide privacy profile data of a first User Equipment (UE1) and a second user equipment (UE2), and wherein the privacy profile data indicates whether a first user consent to share location information associated with the UE1 is present and whether a second user consent to share location information associated with the UE2 is present;
receive the privacy profile data from the UDM;
evaluate the privacy profile data of the UE1 and UE2;
initiate a sidelink positioning procedure and/or a ranging procedure in case the preceding evaluation has resulted in the presence of the first user consent to share location information associated with the UE1 and in the presence of the second user consent to share location information associated with the UE2.

According to a further aspect of the present disclosure, a network system is proposed that can be implemented in a communication system, in particular to be implemented in a 5G communication system, wherein the network system comprises a network function (NF), a unified data management function (UDM) and an access and mobility management function (AMF), wherein the UDM is configured to:
receive a data retrieval request from the NF, wherein the data retrieval request prompts the UDM to provide privacy profile data of the UE1 and the UE2, and wherein the privacy profile data indicates whether a first user consent to share location information associated with the UE1 is present, and whether a second user consent to share location information associated with the UE2 is present;
retrieve the privacy profile data of the UE1 and the UE2 from a database within the UDM, in particular from a unified data repository (UDR) of the UDM; and
sending the retrieved privacy profile data of the UE1 and the UE2 to the NF.

According to a further aspect of the present disclosure, a network system is proposed that can be implemented in a communication system, in particular in a 5G communication system, wherein the network system comprises a network function (NF), a unified data management function (UDM) and an access and mobility management function (AMF), wherein the AMF is configured to:
receive a request message for obtaining the position estimation data for the UE1 and/or the UE2 being associated with an area-specific consent data from the NF or from the UDM;
send the requested position estimation data for the UE1 and/or the UE2 associated with the area-specific consent data to the requesting NF or the requesting UDM.

According to a further aspect of the present disclosure, a computer program product is proposed that, when executed by a processing unit, causes the processing unit to perform the method according to any one of the above-described methods.

### BRIEF DESCRIPTION OF ACCOMPANYING DRAWINGS

Reference will be made to the accompanying drawings which show exemplary embodiments of the present disclosure, wherein the attached figures show the following:

FIG. 1 a schematic representation of a communication system according to an embodiment of the present disclosure,

FIG. 2 a schematic representation of a ranging/sidelink positioning procedure according to an embodiment of the present disclosure,

FIG. 3 a flow chart of one embodiment of the method according to an embodiment of the present disclosure,

FIG. 4 a flow chart illustrating more detailed method steps for evaluating the privacy profile data of the UE1 and the UE2 according to an embodiment of the present disclosure,

FIG. 5 a flow chart illustrating more detailed method steps for obtaining position estimation data for the UE1 and/or the UE2 being associated with area-specific consent data according to an embodiment of the present disclosure,

FIG. 6 a schematic representation of a further embodiment of the method according to the present disclosure, wherein the NF is configured to communicate with the AMF via the UDM,

FIG. 7 a schematic representation of a further embodiment of the method according to the present disclosure, wherein the NF is configured to communicate directly with the AMF, and

FIG. 8 a schematic representation of a User Equipment according to an embodiment of the present disclosure.

### DETAILED DESCRIPTION OF EMBODIMENTS

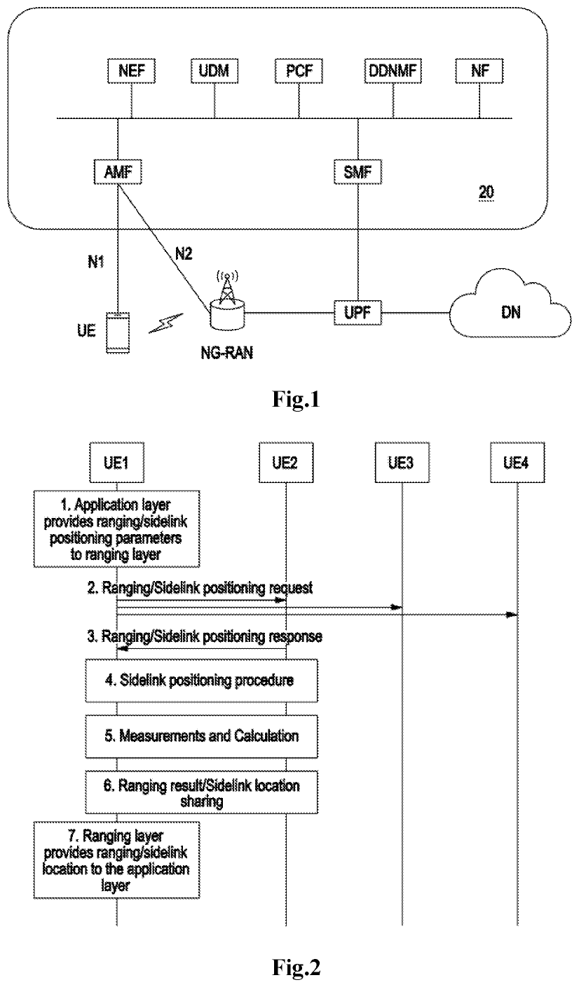

In FIG. 1, a schematic representation of a communication system according to an embodiment of the present disclosure is illustrated. The communication system shown in FIG. 1 corresponds to a typical 5G communication system as known from the prior art. The communication system comprises a network system 20, a User Equipment (UE), an access network (referred to as the NG-RAN or Next Generation Radio Access Network), a user plane function (UPF) and a data network (DN). The network system 20 comprises several functions such as the access and mobility management function (AMF), the session management function (SMF), the network exposure function (NEF), the unified data management (UDM) the policy control function (PCF), the direct discovery name management service (DDNMF) and an additional network function (NF). The UE connects to the network system 20 via interface N1. More specifically, the UE connects to the AMF of the network system 20 via interface N1. Furthermore, the AMF connects to the NG-RAN via interface N2. The different functions of the network system 20 can interact with each other and exchange data. For instance, the UDM may provide subscription data of the user equipment to other network functions. Data retrieval from the UDM may be initiated by sending a corresponding request to the UDM. The network system 20 is connected with the UPF, which is connected with the DN. The communication system as illustrated in FIG. 1 is in principle known as a 5G communication system according to the prior art. However, the present disclosure may also be implemented in other communication systems that do not completely fulfill all requirements of the 5G communication standard, but only implement some of the core elements that are involved in the method according to the present disclosure.

In FIG. 2, a schematic representation of a ranging/SL positioning procedure according to an embodiment of the present disclosure is illustrated. In step 1, the application layer provides the ranging/SL positioning parameters to the ranging layer. In step 2, the first user equipment UE1 may send a ranging/SL positioning request to a second equipment UE2, to a third user equipment UE3, and/or to a fourth user equipment UE4. The ranging/SL positioning request may be broadcasted from the UE1 to the other UEs. The corresponding message may include UE1's application layer ID, the target UE's application ID and required quality of service (QoS). In response to receiving the ranging/SL positioning request, UE2 may return a ranging/SL positioning response to UE1, if the application layer ID for UE2 matches (see step 3). Subsequently, in steps 4 to 6, UE1 may initiate the SL positioning procedure, UE1 or UE2 may obtain the positioning measurements and calculate the ranging/SL positioning result, and UE1 and UE2 may share the ranging/SL positioning result. Finally, in step 7, the ranging layer of UE1 may provide the ranging/SL positioning result to the application layer.

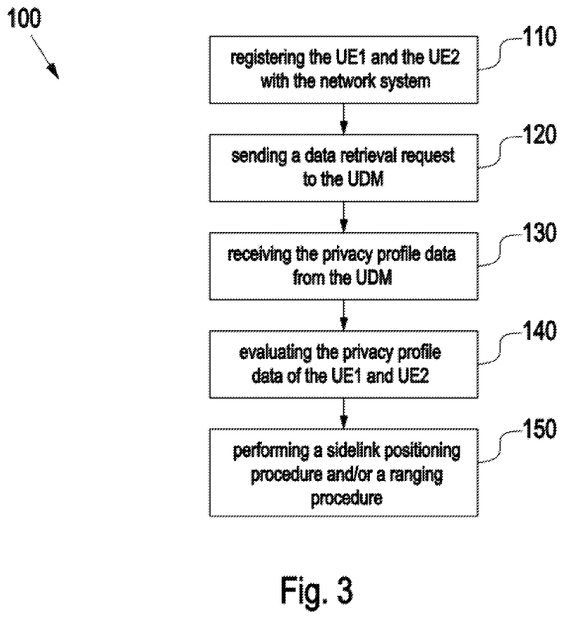

In FIG. 3, an embodiment of method 100 according to the present disclosure is illustrated. In a first step 110, UE1 and UE2 are registered with the network system. This step is typically conducted by the AMF of the network system. After the registration process, some subscription data regarding UE1 and UE2 may be stored in a database of the UDM. In a second step 120, the NF sends a data retrieval request to the UDM. The data retrieval request prompts the UDM to provide privacy profile data of both the UE1 and the UE2. The privacy profile data indicates whether the consent of a first user is granted to share location information associated with the UE1, and whether the consent of a second user is granted to share location information associated with the UE2. In a third step 130, the NF receives the privacy profile data from the UDM. In a fourth step 140, the NF evaluates the received privacy profile data associated with the UE1 and UE2. In a fifth step 150, the SL positioning/ranging procedure is performed, in case the preceding evaluation in step 140 has resulted in the presence of the first user consent to share location information associated with the UE1 and in the presence of the second user consent to share location information associated with the UE2. In other words, the SL positioning/ranging procedure is initiated in case the first user and the second user have granted their consent that the location information of their UE may be shared with the network system.

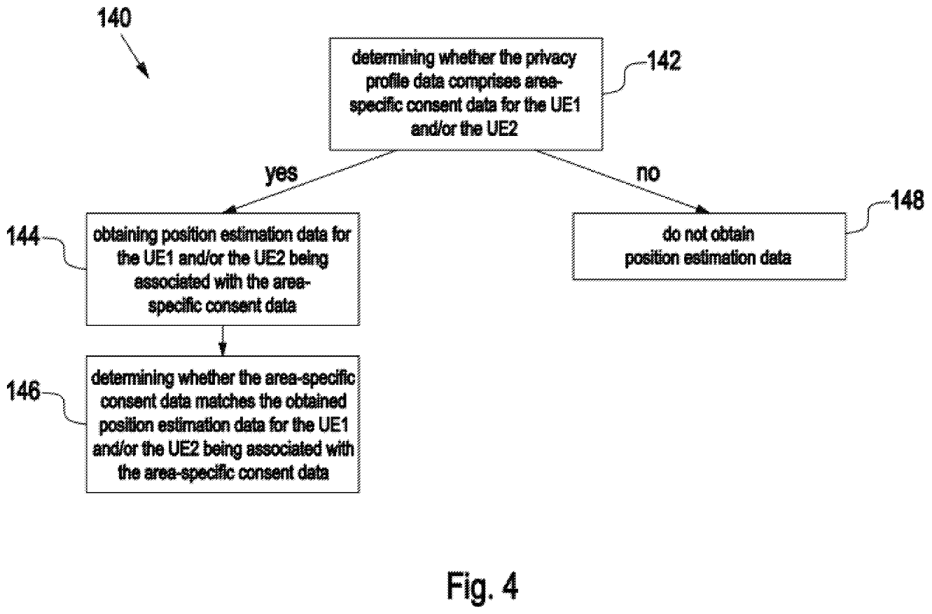

In FIG. 4, the method steps for evaluating 140 the privacy profile data of the UE1 and the UE2 according to an embodiment of the present disclosure are illustrated in more detail. According to a first substep 142, it is determined whether the privacy profile data received by the UDM comprises area-specific consent data for the UE1 and/or the UE2. This determination step is conducted by the NF, which can be the AMF or any other network function of the network system. In case it is determined that the privacy profile data comprises area-specific consent data for at least one of the UE1 and UE2, in a second substep 144, position estimation data for the UE1 and/or the UE2 associated with the area-specific consent data is obtained by the NF. If the privacy profile data comprises area-specific consent data for both of the UEs, position estimation data is obtained for each of the UEs accordingly. For obtaining position estimation data, any of the procedures known from the prior art can be implemented. For instance, the NF may estimate the position of UE1/UE2 by evaluating the cell-ID of UE1/UE2. Further, the tracking area identity (TAI) may be used to determine the (rough) position of one of the UEs. In a third substep 146, the NF determines whether the area-specific consent data matches the obtained position estimation data for the UE1 and/or the UE2 being associated with the area-specific consent data. For instance, if the area-specific consent data indicates that the consent of the first user to share his location information is granted for a specific city and the position estimation data indicates that the first user (i.e. his User Equipment UE1) is located in the same city, the obtained position estimation data matches with the area-specific consent data. In this case, it is determined that the user consent for sharing location information is granted for the current position of the first user. However, if the user consent for sharing location information is not granted for the current position of the first user, the ranging/SL positioning procedure may be aborted and a corresponding notification may be generated. If the first substep 142 has yielded that no area-specific consent data is comprised in the privacy profile data for both UE1 and UE2, no position estimation data is obtained (see substep 148).

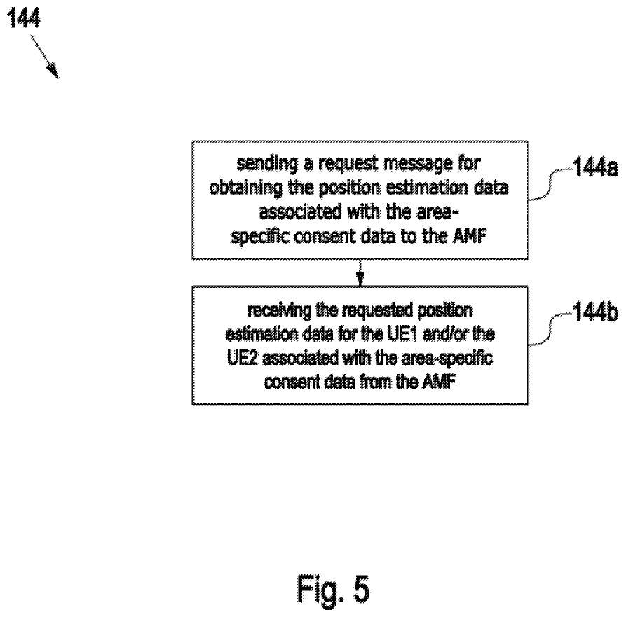

In FIG. 5, the method steps for obtaining 144 position estimation data for the UE1 and/or the UE2 being associated with the area-specific consent data according to an embodiment of the present disclosure are illustrated in more detail. According to the embodiment illustrated in FIG. 5, a request message for obtaining the position estimation data associated with the area-specific consent data is sent from the NF to the AMF in a first substep 144a. Subsequently, in a second substep 144b, the NF receives the requested position estimation data for the UE1 and/or the UE2 associated with the area-specific consent data from the AMF. The steps illustrated in FIG. 5 are not needed in case the NF is identical with the AMF.

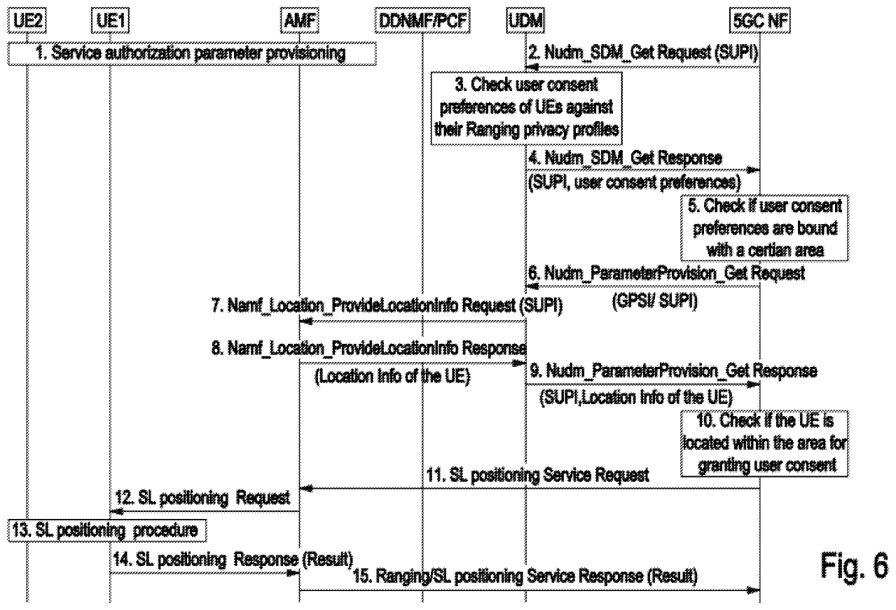

In FIG. 6, a further embodiment of the method according to the present disclosure is illustrated, wherein the NF is configured to communicate with the AMF by the UDM. According to the embodiment illustrated in FIG. 6, the NF is implemented as a 5G core network function (5GC NF). The method steps implemented in the embodiment illustrated in FIG. 6 are as follows:

Step 1: Service authorization and policy/parameters provisioning procedure is performed between UE1/UE2 and the network system respectively.

Step 2: The 5GC NF sends a message to the UDM (e.g. Nudm_SDM_Get Request) to discover the serving AMF of UE1/UE2 based on the UE1/UE2 ID (e.g. GPSI of UE1/UE2). In case the 5GC NF is the serving AMF of the UEs, the AMF discovery is not needed. The 5GC NF may also check with the UDM whether the AF is authorized to acquire SL position of UE1 and UE2. Meanwhile, the 5GC NF requests the user consent preferences of UE1 and UE2 from the UDM. It is noted that for UE1 and UE2 (reference and target UEs), which can discover each other for SL positioning, should preferably be in the vicinity of each other. Hence the UEs are preferably served by the same serving AMF.

Step 3: The UDM checks the user consent preferences of UE1 and UE2 against the SL positioning privacy profiles of the UEs based on the UE1 ID and UE2 ID.

Step 4: The UDM returns the user consent preferences of the UEs to the 5GC NF.

Step 5: The 5GC NF checks the user consent preferences of both UEs. If none of the UEs grants or only one of the UEs does not grant user consent for SL positioning, the 5GC NF aborts the network assisted SL positioning service. In case both UEs grant user consent without location restriction, the 5GC NF proceeds to step 11. In case both UEs grant user consent, which is however restricted to a certain area, the 5GC NF proceeds with step 6. If the 5GC NF is identical with the AMF of the UEs, the 5GC NF skips the steps 6 to 9 and proceeds with step 10.

Step 6: The 5GC NF sends a request message (e.g. Nudm_ParameterProvision_Get Request) to the UDM for requesting the rough location of UE1/UE2 (e.g. TAI or Cell-ID of UE1/UE2).

Step 7: The UDM sends a request message (e.g. Namf_Location_ProvideLocationInfo Request) to the AMF.

Step 8: The AMF of UE1/UE2 sends a response message (e.g. Namf_Location_ProvideLocationInfo Response) to the UDM which contains the rough location of UE1/UE2 (e.g. TAI or Cell-ID of UE1/UE2).

Step 9: The UDM returns a message (e.g. Nudm_ParameterProvision_Get Response) to the 5GC NF which contains the rough location of UE1/UE2 (e.g. TAI or Cell-ID of UE1/UE2).

Step 10: Based on the rough location of UE1/UE2, the 5GC NF checks whether the UE1/UE2 is within the area for granting the user consent.

Step 11: If both UEs grant user consent in their current locations, the 5GC NF sends the SL positioning service request to the AMF of the UEs (e.g. UE1). If the 5GC NF is the AMF, this step can be skipped.

Step 12: The AMF forwards the SL positioning service request to the UE1 over NAS. It is noted that UE1 can be either the target UE or the reference UE, depending on the request from the 5GC NF.

Step 13: UE1 initiates SL positioning procedure to UE2 to trigger the measurement and the calculation of the result. The SL positioning procedure includes Sidelink positioning discovery and service operations.

Step 14: UE1 sends the SL positioning result to the AMF.

Step 15: The AMF forwards the SL positioning result to the 5GC NF. If the 5GC NF is the AMF, this step can be skipped.

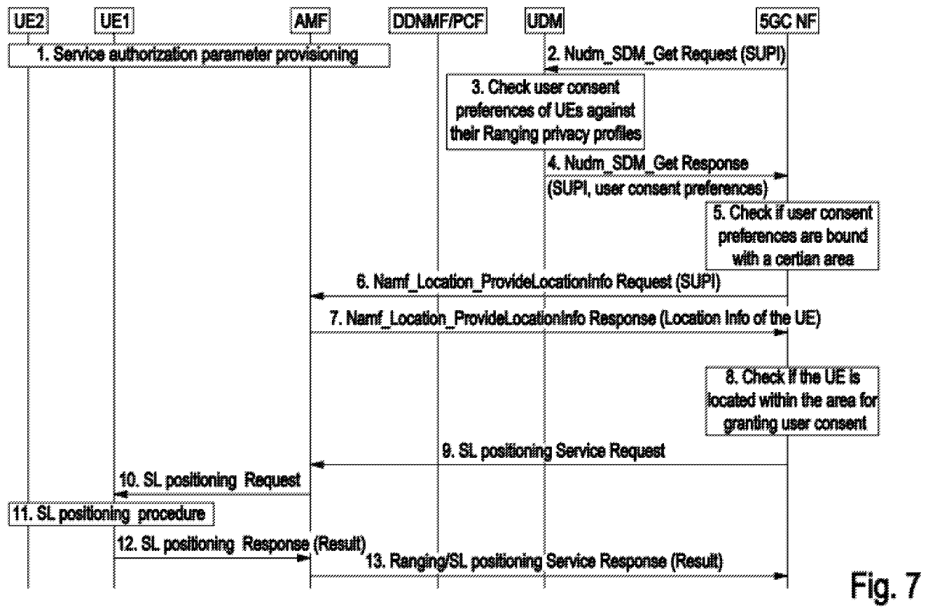

In FIG. 7, a further embodiment of the method according to the present disclosure is illustrated, wherein the NF is configured to communicate directly with the AMF (and not via the UDM according to the embodiment shown in FIG. 6). Similar to the embodiment illustrated in FIG. 6, the NF is implemented again as a 5G core network function (5GC NF) in the embodiment shown in FIG. 7. According to the embodiment illustrated in FIG. 7, the communication between the NF and the AMF is conducted in a direct manner (see steps 6 and 7 in FIG. 7). Apart from the direct communication between the NF and the AMF illustrated in steps 6 and 7, the further steps 1 to 5 and 8 to 13 depicted in FIG. 7 correspond to steps 1 to 5 and 10 to 15 shown in FIG. 6.

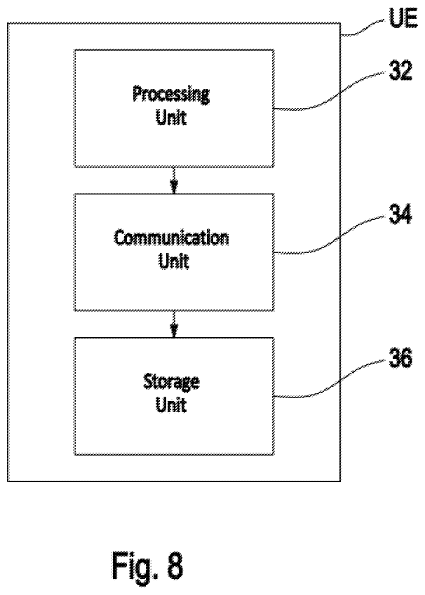

Finally, in FIG. 8, a user equipment (UE) according to the present disclosure is illustrated. The UE comprises a processing unit 32, a communication unit 34 and a storage unit 36.

The present disclosure allows to efficiently handle user privacy preferences without affecting the ranging/SL positioning procedure in a disadvantageous manner. Furthermore, the present disclosure allows to implement the additional measures to existing network architectures without causing any compatibility issues.

The communication system according to the present disclosure may be a 5G communication system or any other communication system based on the architecture of the 5G communication system. For instance, the method according to the present disclosure can also be applied to a communication system that is based on the 5G standard, but does not comprise all functions provided within the 5G standard. Further, the method can be applied to a communication system that includes further additional functions that are not encompassed by the 5G standard (for instance in a future communication standard comprising basically the same network architecture, in particular comprising the same functions as recited above and involved in the method according to the present disclosure). In an embodiment, the network system may be implemented as a 5G core network system.

The ranging/SL positioning procedure can be performed between a first and a second UE. However, the ranging/SL positioning procedure can also encompass additional UEs. Ranging refers to the procedure of determining the distance between two or more UEs via a PC5 interface. SL positioning refers to the procedure of positioning a UE using the PC5 interface.

The network system according to the present disclosure may be a computer system comprising a processing unit, a memory unit, and a communication unit.

The network function may be a location management function (LMF), an access and mobility management function (AMF) or any other network function. Hence, in some embodiments of the present disclosure, the NF may be identical or different from the AMF, as will be further elaborated below. An AMF is typically configured to interact with an access network and with UEs. The AMF may support establishing an encrypted signaling connection towards a UE, wherein the AMF may allow it to register, to be authenticated and to be moved between different radio cells of the network. An LMF may be configured to provide functionality to determine the location of a UE.

According to the present disclosure, the registration of UE1/UE2 with the network system may include the registration of UE1/UE2 with the AMF and the exchange of authorization data, setting parameters, etc. between each of the UEs and the AMF.

Sending, by the NF, a data retrieval request to the UDM may comprise sending a UE1 ID and a UE2 ID for identifying each of the UEs.

The privacy profile data may comprise different types of information. For instance, the privacy profile data may comprise a first binary flag indicating whether a user consent is granted for UE1 and a second binary flag indicating whether a user consent is granted for UE2. Furthermore, in order to enable the handling of more specific privacy preferences, the privacy profile data may comprise area-specific consent data or time-specific consent data. Hence, the privacy profile data may indicate an absolute grant of consent for sharing location information or a consent for sharing location information that depends on predetermined conditions. In an embodiment, the privacy profile data for at least one of the UEs may be bound to a SUPI or a GPSI of the corresponding UE.

In an embodiment, evaluating the privacy profile data of the UE1 and UE2 comprises:
determining, by the NF, whether the privacy profile data comprises area-specific consent data for the UE1 and/or the UE2; and
in case it is determined that the privacy profile data comprises area-specific consent data for the UE1 and/or the UE2:
obtaining, by the NF, position estimation data for the UE1 and/or the UE2 being associated with the area-specific consent data; and
determining, by the NF, whether the area-specific consent data matches the obtained position estimation data for the UE1 and/or the UE2 being associated with the area-specific consent data.

The area-specific consent data can also be referred to as area-depending consent data. For instance, the area-specific consent data may indicate that a user consent is granted for a specific area, e.g. for a specific country, province, city, district or street. The indicated area may be encoded in location data in text format or by way of GPS location data. For instance, the area-specific consent data may comprise different fields indicating the country and the city for which the user consent is granted. As an alternative, the area-specific consent data may comprise a GPS location defining a specific position and additional distance data indicating at which distance from the encoded GPS position the user consent is granted. The area-specific consent data may define a coherent area or, alternatively, separate areas that are not connected with each other. For instance, the area-specific consent data may define two cities of different provinces or two streets in different cities for which the user's consent to share location information is granted.

In an embodiment, the NF is different from the AMF, wherein obtaining position estimation data for the UE1 and/or the UE2 being associated with the area-specific consent data comprises:
sending, by the NF, a request message for obtaining the position estimation data for the UE1 and/or the UE2 being associated with the area-specific consent data, to the AMF;
receiving, by the NF, the requested position estimation data for the UE1 and/or the UE2 being associated with the area-specific consent data from the AMF.

In an embodiment, sending a request message for obtaining the position estimation data for the UE1 and/or the UE2 being associated with the area-specific consent data may comprise:
sending, by the NF, the request message for obtaining the position estimation data for the UE1 and/or the UE2 being associated with the area-specific consent data to the UDM; and
sending, by the UDM, the request message for obtaining the position estimation data for the UE1 and/or the UE2 being associated with the area-specific consent data to the AMF; and/or
receiving the requested position estimation data for the UE1 and/or the UE2 being associated with the area-specific consent data from the AMF may comprise:
receiving, by the UDM, the requested position estimation data for the UE1 and/or the UE2 being associated with the area-specific consent data from the AMF; and receiving, by the NF, the requested position estimation data for the UE1 and/or the UE2 being associated with the area-specific consent data from the UDM.

Hence, according to different embodiments of the present disclosure discussed above, the communication between the NF and the AMF may be carried out directly or indirectly via the UDM.

In an embodiment, evaluating the privacy profile data of the UE1 and the UE2 comprises:
determining whether the privacy profile data comprises time-specific consent data for the UE1 and/or the UE2; and
in case it is determined that the privacy profile data comprises time-specific consent data for the UE1 and/or the UE2:
determining whether requirements of the time-specific consent data are satisfied.

The time-specific consent data may also be referred to as time-depending consent data. For instance, the time specific consent data may comprise predetermined fields indicating specific days of the week and/or specific hours for which a user consent to share location information is granted. According to one illustrative example, the time-specific consent data may indicate that a user consent is granted Mondays to Fridays from 8 AM to 5 PM. Outside the defined time, a user might not consent to sharing his location information. Alternatively, the time-specific consent data may indicate a specific time for which the user consent is not granted. For instance, the time-specific consent data may indicate that sharing location information shall not be shared from Friday 5 PM to Monday 8 AM. In a similar manner, the time-specific consent data may indicate that location information may be shared on specific days of each month or may not be shared during a specific period of the year.

In an embodiment, performing the sidelink positioning procedure and/or the ranging procedure in case the preceding evaluation has resulted in the presence of the first user consent to share location information associated with the UE1 and in the presence of the second user consent to share location information associated with the UE2 comprises:
sending, by the NF, a sidelink positioning procedure request and/or a ranging procedure request to the UE1;
initiating, by the UE1, the requested sidelink positioning procedure and/or the requested ranging procedure with UE2;
providing, by the UE1, a sidelink positioning procedure result and/or the ranging procedure result to the NF.

The communication between the NF and the UE1 may be directly (in particular if the NF is identical to the AMF) or may be indirectly via the AMF (if the NF is not identical to the AMF, as will be discussed below).

In an embodiment, the NF is different from the AMF and
sending a sidelink positioning procedure request and/or a ranging procedure request to the UE1 comprises:
sending, by the NF, a sidelink positioning procedure request and/or a ranging procedure request to the AMF; and
sending, by the AMF, a sidelink positioning procedure request and/or a ranging procedure request to the UE1;
and
providing a sidelink positioning procedure result and/or the ranging procedure result to the NF comprises:
providing, by the UE1, a sidelink positioning procedure result and/or the ranging procedure result to the AMF; and
providing, by the AMF, a sidelink positioning procedure result and/or the ranging procedure result to the NF.

Hence, the NF may communicate with the UE1 indirectly via the AMF.

According to a further aspect of the present disclosure, a method is proposed for providing, by a unified data management (UDM), assistance information to a network function (NF), for performing a sidelink positioning procedure and/or a ranging procedure in a communication system, in particular in a 5G communication system, wherein the communication system comprises a network system, a first User Equipment (UE1) and a second User Equipment (UE2), and wherein the network system comprises the network function (NF), the unified data management function (UDM) and an access and mobility management function (AMF), the method comprising:
receiving, by the UDM, a data retrieval request from the NF, wherein the data retrieval request prompts the UDM to provide privacy profile data of the UE1 and the UE2, and wherein the privacy profile data indicates whether a first user consent to share location information associated with the UE1 is present, and whether a second user consent to share location information associated with the UE2 is present;
retrieving, by the UDM, the privacy profile data of the UE1 and the UE2 from a database within the UDM, in particular from a unified data repository (UDR) of the UDM; and
sending, by the UDM, the retrieved privacy profile data of the UE1 and the UE2 to the NF.

The UDM may be implemented as a front-end for user subscription data stored in a database. The database may also be referred to as a unified data repository (UDR). Typically, when a UE attaches to the network system, the UDM authorizes the access and performs several checks of supported features. Among others, subscription data is stored in the UDM, wherein the subscription data typically defines various types of network or user policies. The data stored within the UDM is offered as services to other network functions (NFs), in particular to the AMF, the PCF and the NEF.

In an embodiment, the UDM is configured to receive privacy profile data of the UE1 and the UE2 to update its database with regard to current privacy settings of the UE1 and UE2. The privacy profile data may be stored as subscription data in the UDR.

In an embodiment, the privacy profile data comprises area-specific consent data for the UE1 and/or the UE2.

In an embodiment, the method may comprise:
receiving, by the UDM, a request message for obtaining position estimation data for the UE1 and/or the UE2 being associated with the area-specific consent data from the NF;
sending, by the UDM, a request message for obtaining the position estimation data for the UE1 and/or the UE2 being associated with the area-specific consent data to the AMF;
receiving, by the UDM, the requested position estimation data for the UE1 and/or the UE2 being associated with the area-specific consent data from the AMF; and
sending, by the UDM, the requested position estimation data for the UE1 and/or the UE2 being associated with the area-specific consent data to the NF.

In an embodiment, the privacy profile data comprises time-specific consent data for the UE1 and/or the UE2.

According to a further aspect of the present disclosure, a method is proposed for providing, by an access and mobility management function (AMF), position estimation data for a first User Equipment (UE1) and a second User Equipment (UE2) for performing a sidelink positioning procedure and/or a ranging procedure in a communication system, in particular in a 5G communication system, wherein the communication system comprises a network system, the first User Equipment (UE1) and the second User Equipment (UE2), and wherein the network system comprises a network function (NF), a unified data management function (UDM) and the access and mobility management function (AMF), the method comprising:
receiving, by the AMF, a request message for obtaining the position estimation data for the UE1 and/or the UE2 being associated with an area-specific consent data from the NF or from the UDM;
sending, by the AMF, the requested position estimation data for the UE1 and/or the UE2 associated with the area-specific consent data to the requesting NF or the requesting UDM.

In an embodiment, the position estimation data comprises a Tracking Areas Identity (TAI) or a cell ID, in particular a NR Cell Global Identifier (NCGI).

According to a further aspect of the present disclosure, a network system is proposed that can be implemented in a communication system, in particular to be implemented in a 5G communication system, wherein the network system comprises a network function (NF), a unified data management function (UDM) and an access and mobility management function (AMF), wherein the NF is configured to:
send a data retrieval request to the UDM, wherein the data retrieval request prompts the UDM to provide privacy profile data of a first User Equipment (UE1) and a second user equipment (UE2), and wherein the privacy profile data indicates whether a first user consent to share location information associated with the UE1 is present and whether a second user consent to share location information associated with the UE2 is present;
receive the privacy profile data from the UDM;
evaluate the privacy profile data of the UE1 and UE2;
initiate a sidelink positioning procedure and/or a ranging procedure in case the preceding evaluation has resulted in the presence of the first user consent to share location information associated with the UE1 and in the presence of the second user consent to share location information associated with the UE2.

The network system may comprise a computing unit, a communication module and a storage medium. The network system may be implemented as a 5G core network system that can be applied in a 5G communication system.

In an embodiment the NF is further configured to:
determine whether the privacy profile data comprises area-specific consent data for the UE1 and/or the UE2; and
in case it is determined that the privacy profile data comprises area-specific consent data for the UE1 and/or the UE2:
obtain position estimation data for the UE1 and/or the UE2 being associated with the area- specific consent data; and
determine whether the area-specific consent data matches the obtained position estimation data for the UE1 and/or the UE2 being associated with the area-specific consent data.

In an embodiment, the NF is different from the AMF and the NF is further configured to:
send a request message for obtaining the position estimation data for the UE1 and/or the UE2 being associated with the area-specific consent data, to the AMF;
receive the requested position estimation data for the UE1 and/or the UE2 being associated with the area-specific consent data from the AMF.

In an embodiment, the NF is further configured to:
send the request message for obtaining the position estimation data for the UE1 and/or the UE2 being associated with the area-specific consent data to the UDM; and
receive the requested position estimation data for the UE1 and/or the UE2 being associated with the area-specific consent data from the UDM.

In an embodiment, the NF is further configured to:
determine whether the privacy profile data comprises time-specific consent data for the UE1 and/or the UE2; and
in case it is determined that the privacy profile data comprises time-specific consent data for the UE1 and/or the UE2:
determine whether requirements of the time-specific consent data are satisfied.

In an embodiment, the NF is further configured to:
send a sidelink positioning procedure request and/or a ranging procedure request to the UE1;
receive a sidelink positioning procedure result and/or the ranging procedure result from the UE1.

In an embodiment, the NF is different from the AMF and the NF is further configured to:
send a sidelink positioning procedure request and/or a ranging procedure request to the AMF; and
receive a sidelink positioning procedure result and/or the ranging procedure result from the AMF.

According to a further aspect of the present disclosure, a network system is proposed that can be implemented in a communication system, in particular to be implemented in a 5G communication system, wherein the network system comprises a network function (NF), a unified data management function (UDM) and an access and mobility management function (AMF), wherein the UDM is configured to:
receive a data retrieval request from the NF, wherein the data retrieval request prompts the UDM to provide privacy profile data of the UE1 and the UE2, and wherein the privacy profile data indicates whether a first user consent to share location information associated with the UE1 is present, and whether a second user consent to share location information associated with the UE2 is present;
retrieve the privacy profile data of the UE1 and the UE2 from a database within the UDM, in particular from a unified data repository (UDR) of the UDM; and
send the retrieved privacy profile data of the UE1 and the UE2 to the NF.

In an embodiment, the UDM is further configured to receive privacy profile data of the UE1 and the UE2 to update its database with regard to current privacy settings of the UE1 and the UE2.

In an embodiment, the privacy profile data comprises area-specific consent data for the UE1 and/or the UE2.

In an embodiment, the UDM is further configured to:
receive a request message for obtaining position estimation data for the UE1 and/or the UE2 being associated with the area-specific consent data from the NF;
send a request message for obtaining the position estimation data for the UE1 and/or the UE2 being associated with the area-specific consent data to the AMF;
receive the requested position estimation data for the UE1 and/or the UE2 being associated with the area-specific consent data from the AMF; and
send the requested position estimation data for the UE1 and/or the UE2 being associated with the area-specific consent data to the NF.

In an embodiment, the privacy profile data comprises time-specific consent data for the UE1 and/or the UE2.

According to a further aspect of the present disclosure, a network system is proposed that can be implemented in a communication system, in particular in a 5G communication system, wherein the network system comprises a network function (NF), a unified data management function (UDM) and an access and mobility management function (AMF), wherein the AMF is configured to:
receive a request message for obtaining the position estimation data for the UE1 and/or the UE2 being associated with an area-specific consent data from the NF or from the UDM;
send the requested position estimation data for the UE1 and/or the UE2 associated with the area-specific consent data to the requesting NF or the requesting UDM.

In an embodiment, the position estimation data comprises a Tracking Areas Identity (TAI) or a cell ID, in particular a NR Cell Global Identifier (NCGI).

According to a further aspect of the present disclosure, a user equipment (UE) is proposed that can be implemented in a communication system, in particular in a 5G communication system, wherein the UE comprises a processing unit, a communication unit and a storage unit, wherein the storage unit has privacy profile data stored thereon, wherein the privacy profile data indicates whether a user consent to share location information associated with the UE1 is present.

In an embodiment, the privacy profile data comprises area-specific consent data.

In an embodiment, the privacy profile data comprises time-specific consent data.

According to a further aspect of the present disclosure, a computer program product is proposed that, when executed by a processing unit, causes the processing unit to perform the method according to any one of the above-described methods.

1. A method for performing a sidelink positioning procedure and/or a ranging procedure in a communication system, wherein the communication system comprises a network system, a first User Equipment (UE1) and a second User Equipment (UE2), and wherein the network system comprises a network function (NF), a unified data management function (UDM) and an access and mobility management function (AMF), and the UE1 and the UE2 registers with the network system, the method comprising:
sending, by the NF, a data retrieval request to the UDM, wherein the data retrieval request prompts the UDM to provide privacy profile data of the UE1 and the UE2, and wherein the privacy profile data indicates whether a first user consent to share location information associated with the UE1 is present and whether a second user consent to share location information associated with the UE2 is present;
receiving, by the NF, the privacy profile data from the UDM;
evaluating, by the NF, the privacy profile data of the UE1 and UE2; and
performing the sidelink positioning procedure and/or the ranging procedure in case the preceding evaluation has resulted in the presence of the first user consent to share location information associated with the UE1 and in the presence of the second user consent to share location information associated with the UE2.

2. The method according to claim 1, wherein evaluating the privacy profile data of the UE1 and UE2 comprises:
determining, by the NF, whether the privacy profile data comprises area-specific consent data for the UE1 and/or the UE2; and
in case it is determined that the privacy profile data comprises area-specific consent data for the UE1 and/or the UE2:
obtaining, by the NF, position estimation data for the UE1 and/or the UE2 being associated with the area-specific consent data; and
determining, by the NF, whether the area-specific consent data matches the obtained position estimation data for the UE1 and/or the UE2 being associated with the area-specific consent data.

3. The method according to claim 2, wherein the NF is different from the AMF, and obtaining position estimation data for the UE1 and/or the UE2 being associated with the area-specific consent data comprises:
sending, by the NF, a request message for obtaining the position estimation data for the UE1 and/or the UE2 being associated with the area-specific consent data, to the AMF;
receiving, by the NF, the requested position estimation data for the UE1 and/or the UE2 being associated with the area-specific consent data from the AMF.

4. The method according to claim 3, wherein
sending the request message for obtaining the position estimation data for the UE1 and/or the UE2 being associated with the area-specific consent data comprises:
sending, by the NF, the request message for obtaining the position estimation data for the UE1 and/or the UE2 being associated with the area-specific consent data to the UDM; and
sending, by the UDM, the request message for obtaining the position estimation data for the UE1 and/or the UE2 being associated with the area-specific consent data to the AMF;
and/or
receiving the requested position estimation data for the UE1 and/or the UE2 being associated with the area-specific consent data from the AMF comprises:
receiving, by the UDM, the requested position estimation data for the UE1 and/or the UE2 being associated with the area-specific consent data from the AMF; and
receiving, by the NF, the requested position estimation data for the UE1 and/or the UE2 being associated with the area-specific consent data from the UDM.

5. The method according to claim 1, wherein evaluating the privacy profile data of the UE1 and the UE2 comprises:
determining whether the privacy profile data comprises time-specific consent data for the UE1 and/or the UE2; and
in case it is determined that the privacy profile data comprises time-specific consent data for the UE1 and/or the UE2:
determining whether requirements of the time-specific consent data are satisfied.

6. The method according to claim 1, wherein performing the sidelink positioning procedure and/or the ranging procedure in case the preceding evaluation has resulted in the presence of the first user consent to share location information associated with the UE1 and in the presence of the second user consent to share location information associated with the UE2 comprises:
sending, by the NF, a sidelink positioning procedure request and/or a ranging procedure request to the UE1;
initiating, by the UE1, the requested sidelink positioning procedure and/or the requested ranging procedure with UE2; and
providing, by the UE1, a sidelink positioning procedure result and/or the ranging procedure result to the NF.

7. The method according to claim 6, wherein the NF is different from the AMF, and wherein
sending the sidelink positioning procedure request and/or the ranging procedure request to the UE1 comprises:
sending, by the NF, the sidelink positioning procedure request and/or the ranging procedure request to the AMF; and
sending, by the AMF, the sidelink positioning procedure request and/or the ranging procedure request to the UE1;
and
providing the sidelink positioning procedure result and/or the ranging procedure result to the NF comprises:
providing, by the UE1, the sidelink positioning procedure result and/or the ranging procedure result to the AMF; and
providing, by the AMF, the sidelink positioning procedure result and/or the ranging procedure result to the NF.

8. A method for providing, by a unified data management (UDM), assistance information to a network function (NF), for performing a sidelink positioning procedure and/or a ranging procedure in a communication system, wherein the communication system comprises a network system, a first User Equipment (UE1) and a second User Equipment (UE2), and wherein the network system comprises the network function (NF), the unified data management function (UDM) and an access and mobility management function (AMF), the method comprising:
receiving, by the UDM, a data retrieval request from the NF, wherein the data retrieval request prompts the UDM to provide privacy profile data of the UE1 and the UE2, and wherein the privacy profile data indicates whether a first user consent to share location information associated with the UE1 is present, and whether a second user consent to share location information associated with the UE2 is present;
retrieving, by the UDM, the privacy profile data of the UE1 and the UE2 from a database within the UDM, the database comprising a unified data repository (UDR) of the UDM; and
sending, by the UDM, the retrieved privacy profile data of the UE1 and the UE2 to the NF.

9. The method according to claim 8, wherein the UDM is configured to receive privacy profile data of the UE1 and the UE2 to update its database with regard to current privacy settings of the UE1 and UE2.

10. The method according to claim 8, wherein the privacy profile data comprises area-specific consent data for the UE1 and/or the UE2.

11. The method according to claim 10, further comprising:
receiving, by the UDM, a request message for obtaining position estimation data for the UE1 and/or the UE2 being associated with the area-specific consent data from the NF;
sending, by the UDM, a request message for obtaining the position estimation data for the UE1 and/or the UE2 being associated with the area-specific consent data to the AMF;
receiving, by the UDM, the requested position estimation data for the UE1 and/or the UE2 being associated with the area-specific consent data from the AMF; and
sending, by the UDM, the requested position estimation data for the UE1 and/or the UE2 being associated with the area-specific consent data to the NF.

12. The method according to claim 8, wherein the privacy profile data comprises time-specific consent data for the UE1 and/or the UE2.

13. A method for providing, by an Access and Mobility Management Function (AMF), position estimation data for a first User Equipment (UE1) and a second User Equipment (UE2) for performing a sidelink positioning procedure and/or a ranging procedure in a communication system, wherein the communication system comprises a network system, the first User Equipment (UE1) and the second User Equipment (UE2), and wherein the network system comprises a network function (NF), a unified data management function (UDM) and the access and mobility management function (AMF), the method comprising:
receiving, by the AMF, a request message for obtaining the position estimation data for the UE1 and/or the UE2 being associated with an area-specific consent data from the NF or from the UDM; and
sending, by the AMF, the requested position estimation data for the UE1 and/or the UE2 associated with the area-specific consent data to the requesting NF or the requesting UDM.

14. The method according to claim 13, wherein the position estimation data comprises a Tracking Areas Identity (TAI) or a cell ID, the cell ID comprising a NR Cell Global Identifier (NCGI).

15. A network system to be implemented in a communication system, comprising:
a network function (NF);
a unified data management function (UDM); and
an access and mobility management function (AMF),
wherein the NF is configured to perform the method according to claim 1.

16.-21. (canceled)

22. A network system to be implemented in a communication system, comprising:
a network function (NF);
a unified data management function (UDM); and
an access and mobility management function (AMF),
wherein the UDM is configured to perform the method according to claim 8.

23.-26. (canceled)

27. A network system to be implemented in a communication system, comprising:
a network function (NF);
a unified data management function (UDM); and
an access and mobility management function (AMF),
wherein the AMF is configured to perform the method according to claim 13.

28.-31. (canceled)

32. A non-transitory computer-readable storage medium storing an instruction that, when executed by a processor, causes the processor to perform the method according to claim 1.
